(19) United States
(12) Patent Application Publication
(10) Pub. No.: US 2006/0212429 A1
(43) Pub. Date: Sep. 21, 2006

(54) Answering top-K selection queries in a relational engine

(75) Inventors: Nicolas Bruno, Redmond, WA (US); Hui Wang, Vancouver (CA)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/082,645

(22) Filed: Mar. 17, 2005

(51) Int. Cl. G06F 7/00

(52) U.S. Cl. 707/3

(57) ABSTRACT

The subject invention leverages threshold-based strategies applied to relational data to facilitate in determining an optimal execution plan for top-k selection queries. These strategies utilize a given query and relational data metadata to identify possible execution plans. This allows alternatives to scanning techniques to be considered in order to further enhance the overall efficiency of the optimal execution plan. A query optimizer can prune, for example, the alternative execution plans during enumeration of the plan space and/or during cost evaluations of the possible alternative execution plans. A cost model for the query optimizer can utilize a cost function based on an approximation of the number of iterations required to complete a threshold-based strategy.

### TECHNICAL FIELD

The subject invention relates generally to data query optimization, and more particularly to systems and methods for determining an optimal query execution plan for relational data via consideration of a threshold-based execution plan determination process.

### BACKGROUND OF THE INVENTION

Increasing advances in computer technology (e.g., microprocessor speed, memory capacity, data transfer bandwidth, software functionality, and the like) have generally contributed to enhanced computer applications in various industries. Increasingly powerful server systems, which are often configured as an array of servers, are commonly provided to service requests originating from external sources such as, for example, the Internet.

As the amount of available electronic data grows, it becomes more important to store such data in a manageable manner that facilitates user friendly and quick data searches and retrieval. A Database Management System (DBMS) can typically manage any form of data including text, images, sound and video. Today, a common approach is to store electronic data in one or more databases. In general, a typical database can be referred to as an organized collection of information with data structured such that a computer program can quickly search and select desired pieces of data. Data within a database is typically organized via one or more tables. Such tables are arranged as an array of rows and columns.

The tables can comprise a set of records, and a record includes a set of fields. Records are commonly indexed as rows within a table and the record fields are typically indexed as columns, such that a row/column pair of indices can reference a particular datum within a table. For example, a row can store a complete data record relating to a sales transaction, a person, or a project. Likewise, columns of the table can define discrete portions of the rows that have the same general data format, wherein the columns can define fields of the records. Queries for such tables can be constructed in accordance to a standard query language (e.g., structured query language (SQL)) in order to access content of a table in the database.

A Relational Database Management System (RDBMS) is another type of database system for storing data and is one of the most effective in storing data and their relationships. Relational database systems are an application of mathematical set theory to the problem of effectively organizing data. In a relational database, data is collected into tables (i.e., relations in relational theory). A table generally represents a class of objects that have an important relationship. For example, a business can have a database with a table for employees, another table for customers, and another for stores. Each table is built of columns and rows (i.e., attributes and tuples in relational theory). Thus, a user can issue queries for tuples of the relational data in the database.

Modern databases often contain vast amounts of information. Even given the computing power and speed of modern computing hardware, queries of large databases can sometimes take several hours to perform. These queries can be computationally intensive both because of the large amount of data that must be searched and because data manipulation operations necessary to place data into a format from which desired information can be extracted can be complex and computationally expensive.

To reduce the computational tasks necessary to extract useful information from a database, a number of techniques have been developed, such as the use of materialized views and the optimization of user queries. When optimizing a user query, a query optimizer typically rewrites a query entered by a user into a form that is less computationally expensive to perform through a series of substitutions of equivalent expressions. Ideally, the final resulting query is in a form that represents the most efficient way of obtaining the data that the user desires.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates generally to query optimization, and more particularly to systems and methods for determining an optimal query execution plan for relational data via consideration of threshold-based execution plan determination processes. Threshold-based strategies applied to relational data are leveraged to facilitate in determining an optimal execution plan for top-k selection queries. These strategies utilize a given query and metadata associated with a relational database to identify possible execution plans. This allows alternatives to scan-based techniques to be considered by a query optimizer in order to enhance the overall efficiency of the optimal execution plan. Pruning of the alternative execution plans can be achieved heuristically during enumeration of the plan space without utilizing a cost model and/or during cost evaluations of the possible alternative execution plans.

Instances of the subject invention can utilize a cost function based on an approximation of the number of iterations required to complete a threshold-based strategy (i.e., based on the complexity of the strategy). In one instance of the subject invention, the approximation is determined utilizing a precomputed small sample to obtain an approximate score of a top-k tuple and single column histograms to obtain a minimum value that results in a threshold value below the approximate score of the top-k tuple. The minimum value is then employed as the approximation in the cost function. Instances of the subject invention can be seamlessly integrated with traditional query optimizers to facilitate in optimizing queries utilizing traditional strategies and/or threshold-based strategies. Query optimizers can yield substantial increases in efficiency of execution plans when threshold-based strategies are considered in determination of an optimal execution plan for a relational database top-k selection query.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a query optimizer system in accordance with an aspect of the subject invention.

FIG. 2 is another block diagram of a query optimizer system in accordance with an aspect of the subject invention.

FIG. 3 is yet another block diagram of a query optimizer system in accordance with an aspect of the subject invention.

FIG. 4 is an illustration of providing sorted accesses using indexes in accordance with an aspect of the subject invention.

FIG. 5 is an illustration of a sample threshold-based execution plan in accordance with an aspect of the subject invention.

FIG. 6 is an illustration of pruning threshold-based strategies in accordance with an aspect of the subject invention.

FIG. 7 is an illustration of approximating D using histograms in accordance with an aspect of the subject invention.

FIG. 8 is a graph of cover data for a three-dimensional query in accordance with an aspect of the subject invention.

FIG. 9 is a graph of Zipfian data for a two-dimensional query in accordance with an aspect of the subject invention.

FIG. 10 is a graph of probability for a rank estimation using samples in accordance with an aspect of the subject invention.

FIG. 11 is a graph of cumulative probability for a rank estimation using samples in accordance with an aspect of the subject invention.

FIG. 12 is a flow diagram of a method of facilitating query optimization in accordance with an aspect of the subject invention.

FIG. 13 is another flow diagram of a method of facilitating query optimization in accordance with an aspect of the subject invention.

FIG. 14 is a flow diagram of a method of estimating an execution plan cost in accordance with an aspect of the subject invention.

FIG. 15 illustrates an example operating environment in which the subject invention can function.

FIG. 16 illustrates another example operating environment in which the subject invention can function.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

Queries in database systems are generally posed in high level, declarative (non-procedural) languages that need to be translated into a procedural execution plan. The purpose of query optimization is to explore the manners in which this declarative request can be translated into procedural plans and to select the most efficient plan among those explored. The desired query execution plan can consist of a series of primitive database operators, and is typically selected according to a least estimated execution cost.

Instances of the subject invention take advantage of threshold-based algorithms to answer top-k queries in a relational database system and provide adaptation of algorithms to the relational world (e.g., utilization of indexes, etc.), plan space enumeration and pruning, and cost modeling to compare alternative execution plans. The answer to a top-k query is an ordered set of tuples, where the ordering is based on how closely each tuple matches the given query. In the context of middleware systems, new algorithms to evaluate top-k queries have been recently proposed, with threshold-based algorithms such as, for example, TA being the most well known instance. TA can evaluate top-k queries without examining all the tuples which is very costly in a middleware system.

The top-k query model is prevalent over middleware systems in general, but also over plain relational data for certain applications. Relational systems do not have all the restrictions that are present in middleware systems (in particular, sequential scans are very efficient). Depending on the available indexes, many alternative threshold-based strategies (e.g., TA and the like) can be utilized to answer a given query. Choosing the most efficient alternative requires employment of a suitable cost model that can be, preferably, seamlessly integrated with that of current and/or future optimizers. Scenarios which can take advantage of threshold-based algorithms to answer top-k queries in a relational database system are characterized infra.

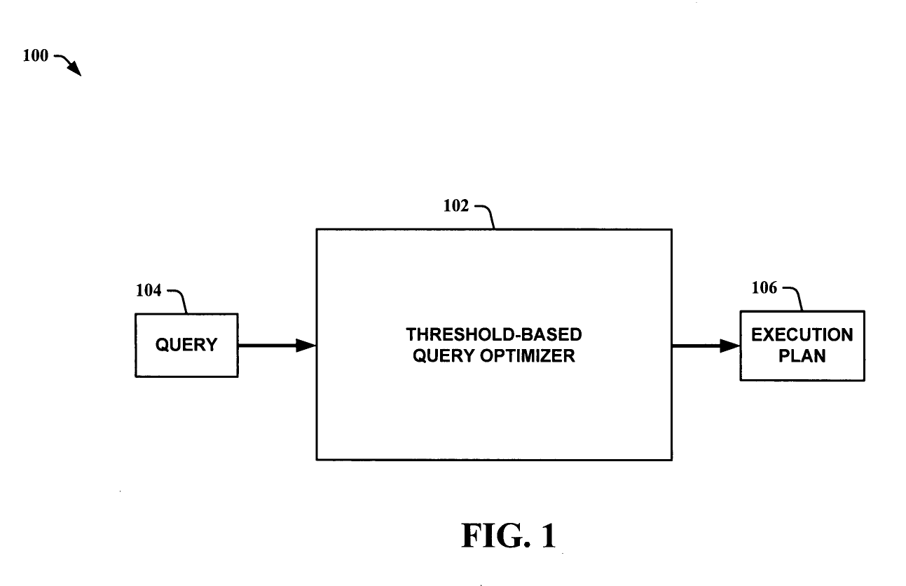

In FIG. 1, a block diagram of a query optimizer system 100 in accordance with an aspect of the subject invention is shown. The query optimizer system 100 is comprised of a threshold-based query optimizer component 102 that receives a top-k selection query 104 and provides an execution plan 106 for relational data. The threshold-based query optimizer component 102 utilizes, at least in part, a process that considers threshold-based execution plans for the top-k selection query 104. This allows instances of the subject invention to be utilized in conjunction with traditional query optimizers that typically employ processes such as, for example, sequential scan techniques to identify execution plans for relational data queries. A traditional query optimizer can incorporate aspects of the subject invention such that a comparison of execution plan costs can be completed to facilitate in determining the most efficient execution plan between traditional-based execution plans and threshold-based execution plans. This allows instances of the subject invention to enhance existing optimizers substantially. Although it is possible that some queries can have no identifiable threshold-based execution plan space, the substantial increases gained by the threshold-based processes makes consideration of the process in conjunction with traditional optimizer techniques a major advantage over traditional techniques alone.

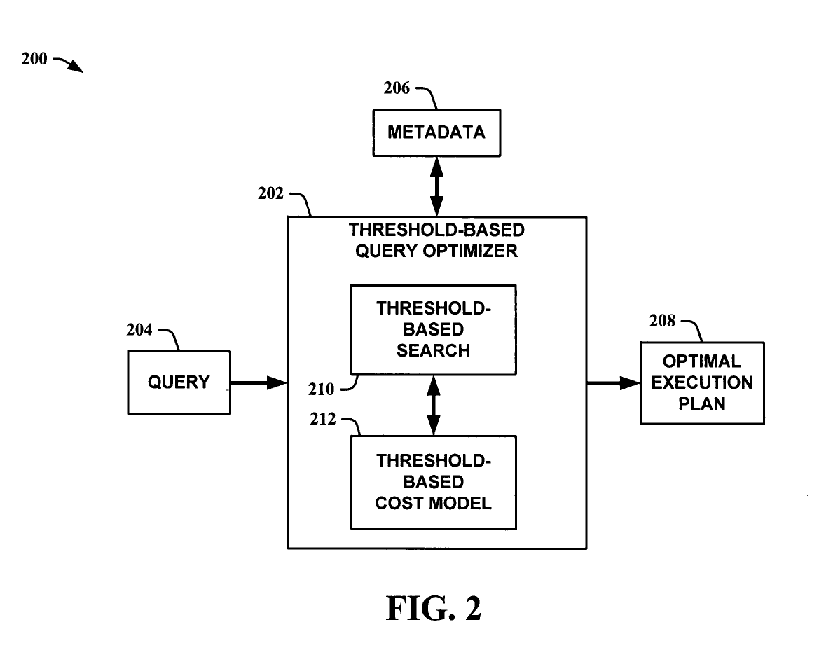

Turning to FIG. 2, another block diagram of a query optimizer system 200 in accordance with an aspect of the subject invention is depicted. The query optimizer system 200 is comprised of a threshold-based query optimizer component 202 that receives a top-k selection query 204 and provides an optimal execution plan 208 utilizing metadata 206 associated with relational data. The threshold-based query optimizer 202 is comprised of, in part, a threshold-based search component 210 and a threshold-based cost model 212. The metadata 206, for example, can be comprised of index structure information for relational data. The threshold-based optimizer 202 utilizes various index-associated techniques to facilitate in determining execution plan space. The employment of these techniques substantially reduces the cost of execution plans by leveraging the efficiency of indexes versus other techniques that require scans of all relational data. Different index related techniques provide different levels of efficiency and are discussed in more detail infra.

The threshold-based query optimizer 202 enumerates execution plan space and can also prune execution plans heuristically in advance without utilizing a cost model. However, the threshold-based cost model 212 is utilized to determine costs of execution plans in the execution plan space to further assist in pruning the candidate or “possible” execution plans. The costs associated with each threshold-based execution plan are determined utilizing threshold-based cost techniques described in detail infra.

Although illustrated as a stand-alone query optimizer, one skilled in the art can appreciate that instances of the subject invention can also be seamlessly incorporated into traditional query optimizers as well. Thus, the functionality of the threshold-based query optimizer 202 and/or its components 210, 212 can be part of a traditional-based query optimizer. When utilized in such manner, the optimal execution plan 208 can become an optimal “threshold-based” execution plan. That is, functionality of the threshold-based query optimizer 202 provides a possible solution to be considered by a traditional-based query optimizer that it facilitates. The overall optimal execution plan can then be the optimal “threshold-based” execution plan or an optimal traditional-based execution plan based on costs and/or availability of the execution plans and the like.

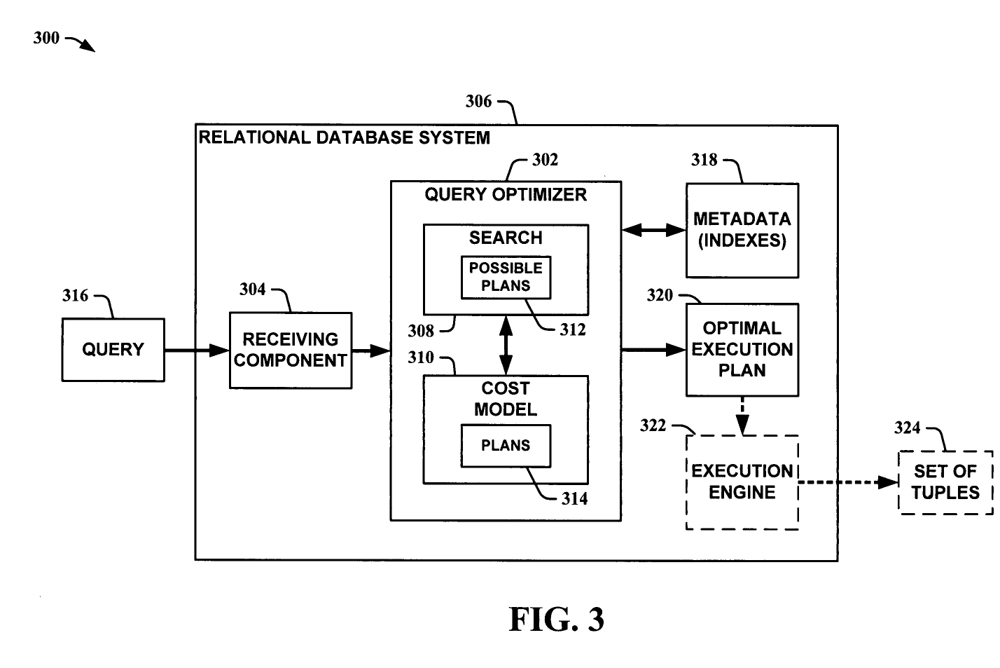

Looking at FIG. 3, yet another block diagram of a query optimizer system 300 in accordance with an aspect of the subject invention is illustrated. The query optimizer system 300 is comprised of a query optimizer component 302 and a receiving component 304 that reside, optionally, in a relational database system 306. The query optimizer 302 is comprised of a search component 308 that can include possible alternative execution plans 312 and a cost model component 310 that can include alternative execution plans 314. The receiving component 304 receives a top-k selection query 316 directed towards relational data in the relational database system 306. In other instances of the subject invention, the receiving component 304 can provide massaging of the top-k selection query 316 such as, for example, by parsing and/or normalizing and the like to prepare the top-k selection query 316 for optimization. The query optimizer 302 receives the top-k selection query 316 from the receiving component 304 and utilizes the search component 312, along with metadata 318 associated with the relational database system 306 to enumerate and/or prune an alternative execution plan space of possible (or “candidate”) alternative execution plans 312 for the query 316. The metadata 318 can include, but is not limited to, indexes and the like of the relational data that indicate structure of the relational data. When employed with traditional systems, instances of the subject invention provide an enhanced execution plan space not obtainable by the traditional strategies alone.

In instances of the subject invention, the cost model component 310 is employed to prune and/or further prune the possible alternative execution plans 312. The alternative execution plans 314 are representative of the alternative execution plans passed to the cost model component 310 and include those alternative execution plans remaining after the possible alternative execution plans 312 have or have not been pruned. Thus, the alternative execution plans 314 can comprise a subset of the possible alternative execution plans 312 or all of the possible alternative execution plans 312 (e.g., if the possible alternative execution plans 312 have not been pruned at all). Typically, the query optimizer 302 prunes heuristically in advance and/or simultaneously to the formation of the possible alternative execution plans 312.

In this instance of the subject invention, the possible alternative execution plans 312 are passed in totality to be evaluated by the cost model component 314 as the alternative execution plans 314. The cost model component 310 evaluates the alternative execution plans 314 to determine a minimal cost alternative execution plan. The minimal cost alternative execution plan can then become an optimal execution plan 320 in some instances of the subject invention or it can be further evaluated by the query optimizer component 302 against costs of execution plans determined via traditional techniques. The lowest cost execution plan of both types of techniques is then the optimal execution plan 320.

Thus, instances of the subject invention can be seamlessly integrated into existing query optimizers to facilitate in enhancing the efficiency of the optimal execution plan 320 rather than replacing traditional-based processes. It is also possible that a particular query might not have an identifiable alternative execution plan space. Therefore, although threshold-based strategies are employed, the optimal execution plan 320 can be, for example, a sequential scan-based execution plan.

One skilled in the art can appreciate that the relational database system 306, at some point, will execute the optimal execution plan 320 via an execution engine 322 to produce a top-k set of tuples 324. The execution engine 322 and the top-k set of tuples 324 are shown dashed in FIG. 3 to indicate that they are optional to the configuration shown in FIG. 3. Thus, although the optimal execution plan 320 is determined, there is no requirement that it 320 be immediately executed after determination.

As stated supra, the answer to a top-k query is an ordered set of tuples, where the ordering is based on how closely tuples match the given query. Thus, the answer to a top-k query does not include all tuples that “match” the query, but instead only the best k such tuples. Consider, for example, a multimedia system with an attribute R_{C} that contains information about the color histogram of each picture and another attribute R_{S} with information about shapes. To obtain a few pictures that feature red circles, a top-10 query with a scoring function that combines (e.g., using a weighted average) the redness score of each picture (provided by R_{C}) with its “circle” score (provided by R_{S}) can be employed. Other applications that rely on this type of model are information retrieval systems (see, G. Salton; Automatic Text Processing: The transformation, analysis, and retrieval of information by computer; Addison-Wesley, 1989), data broadcast scheduling (see e.g., D. Aksoy and M. Franklin; RxW: A scheduling approach for large-scale on-demand data broadcast; ACM Transactions on Networking; 7(6); 1999), and restaurant selection systems (see, A. Marian, N. Bruno, and L. Gravano; Evaluating top-k queries over web-accessible databases; ACM Transactions on Database Systems (TODS); 29(2); 2004) and the like.

One way to evaluate a top-k query is to process all candidate tuples in the database, calculate their scores, and return the k tuples that score the highest (denoted as a scan-based approach since it requires sequentially examining all tuples in the database). In some scenarios, however, the top-k queries can be more efficiently evaluated.

One example of a threshold-based algorithm, the Threshold Algorithm, or TA, was introduced (see, R. Fagin, A. Lotem, and M. Naor; Optimal aggregation algorithms for middleware; In Proc. of the Twentieth ACM Symposium on Principles of Database Systems; 2001) for processing top-k queries in the context of middleware systems. A middleware system (see, Fagin, Lotem, and Naor, Id.) consists of m autonomous data sources that provide access to attributes {c₁, . . . ,cₘ} of all objects in the system. Such sources can be explored using sorted access (in which attribute values are returned in descending order for a given attribute scoring function) and random access (in which the value of an object's attribute is obtained by providing the object's identifier). A top-k query in such scenario is specified by a monotonic function F (e.g., min or weighted average) that aggregates the individual attribute scores.

In a middleware system, the information about an object that is scattered across data sources cannot be efficiently combined. To reconstruct an object from its identifier, several random accesses need to be issued to the data sources (typically one random access per attribute), which is expensive. For that reason, scan-based algorithms are not an efficient alternative in middleware systems. The distinguishing characteristic of TA is the use of an early-termination condition that allows returning the top-k elements without examining the values of all tuples in the system. At the same time, TA requires a bounded amount of memory to operate (independent of the data size and distribution) and is straightforward to implement (alternative algorithms, such as NRA or CA (see, Fagin, Lotem, and Naor, Id.)), require, in the worst case, as much memory as the data size itself and rely on complex bookkeeping which make implementations non-trivial).

These issues pose obstacles to the utilization of TA, which was designed specifically for middleware systems, in a Relational Database Management System (RDBMS). The reconstruction problem of scan-based algorithms is not severe in a RDBMS because each row in a table generally contains all attributes of the object being represented. Instances of the subject invention can facilitate in determining when threshold-based algorithms are a beneficial alternative in an RDBMS and when they fail to provide substantial benefit.

There has been a significant amount of research on top-k queries in the recent literature. Although the middleware algorithm is referred to as TA (see, Fagin, Lotem, and Naor, Id.), slight variations of TA were independently proposed (see, U. Güntzer, W. T. Balke, and W. Kieβling; Optimizing multi-feature queries for image databases; In Proceedings of the International Conference on Very Large Databases; 2000; and S. Nepal and M. V. Ramakrishna; Query processing issues in image (multimedia) databases; In Proceedings of the International Conference on Data Engineering; 1999). Thereafter, techniques (see, K. Chang and S. won Hwang; Minimal probing: supporting expensive predicates for top-k queries; In Proceedings of the ACM International Conference on Management of Data (SIGMOD); 2002; and Marian, Bruno, and Gravano), among others, extended the basic algorithms to work with middleware sources that restrict their access capabilities. An evaluation (see, E. Wimmers, et al.; Using Fagin's algorithm for merging ranked results in multimedia middleware; In International Conference on Cooperative Information Systems; 1999) was conducted of an earlier algorithm that efficiently answers top-k queries (see, R. Fagin; Combining fuzzy information from multiple systems; In Proceedings of the Fifteenth ACM Symposium on Principles of Database Systems (PODS'96); 1996). The techniques implemented the algorithm in the Garlic middleware system and explored its strengths and weaknesses. Later, techniques (see, Fagin, Lotem, and Naor) showed that TA is more efficient than the earlier algorithm (see, Fagin).

One technique (see, I. Ilyas, et al.; Rank-aware query optimization; In Proceedings of the ACM International Conference on Management of Data (SIGMOD); 2004) focused on the problem of integrating top-k join queries in relational databases. The assumption in that technique is that the contribution of each table to the overall scoring function depends on just one attribute in the table. Therefore, the main problem consists of introducing non-blocking rank-aware join operators and reordering the joins in the final execution plan to minimize the overall cost. In contrast, instances of the subject invention focus on complex top-k queries over a single table and exploit indexes to evaluate such queries efficiently. The resulting execution plans returned by instances of the subject invention can be utilized as the leaf nodes in the join plans of the supra technique (see, Ilyas et al.), thus, extending the set of top-k queries that can be evaluated without scanning the underlying tables.

Techniques to evaluate top-k queries through traditional SQL order by clauses exist (see, M. J. Carey and D. Kossmann; On saying “Enough Already!” in SQL; In Proceedings of the 1997 ACM International Conference on Management of Data; 1997). These techniques leverage the fact that when k is relatively small compared to the size of the relation, specialized sorting (or indexing) techniques that can produce the first few values efficiently should be used. However, in order to apply these techniques for the types of scoring functions of instances of the subject invention, the scoring function for each database object needs to be evaluated first. Hence, these strategies require a sequential scan of all data as a preprocessing step.

TA Algorithm

Consider a top-k query over attributes c₁, . . . , cₘ and a scoring function F(s₁(c₁), . . . ,sₘ(cₘ)), where sᵢ is the scoring function of attribute cᵢ. Suppose that source Rᵢ handles attribute cᵢ. The TA algorithm to obtain the k objects with the best scores is now summarized.
Do a sorted access in parallel to each of the m sources. As an object O is seen under sorted access in source Rᵢ, do random accesses to the other sources Rⱼ and calculate the remaining attribute scores sⱼ of object O. Compute the overall score F(s₁, . . . ,sₘ) of object O. If this value is one of the k highest seen so far, remember object O and its score (break ties arbitrarily).
Let sᵢ^{L} be the score of the last object seen under sorted access for source Rᵢ. Define the threshold value T to be F(s₁^{L}, . . . ,sₘ^{L}). If the score of the current top-k object if worse than T, return to the above step.
Return the current top-k objects as the query answer.

Correctness of TA follows from the fact that the threshold value T represents the best possible score that any object not yet seen can have, and TA stops when it can guarantee that no unseen object might have a better score than the current top-k ones. The algorithm (see, Fagin, Lotem, and Naor) was later extended to support scenarios in which some sources cannot provide sorted access. In such situations, sᵢ^{L} needs to be replaced with the maximum possible score for each source Rᵢ that cannot provide sorted access.

RDBMS Context Issues

In the context of a RDBMS, the following problem is encountered. Consider table R with attributes c₁, . . . ,cₘ (and possibly other attributes not mentioned in the query). A top-k query in SQL is specified as follows in TABLE 1 (Queries might have additional columns in the SELECT clause that are not present in the ORDER BY clause. This results in minor variations to techniques of instances of the subject invention, but such details are omitted for simplicity.):

TABLE 1
Top-k Query in SQL

SELECT TOP(k) cl, ..., cm
FROM R
WHERE P
ORDER BY F(sₗ(cl), ..., sₘ(cm)) DESC

where P is a filter predicate, F is a monotonic aggregate function, and sᵢ are individual attribute scoring functions. In current database systems, the best way to evaluate such top-k query is a scan-based approach. Conceptually, the best execution plan is first obtained for the following query in TABLE 2:

TABLE 2
Determine Best SQL Execution Plan

SELECT cl,..., cm, F(sₗ(cl),..., sₘ(cm)) as S
FROM R
WHERE P

and then a partial-sort operator is applied on column score on top of this execution plan. A partial-sort operator scans its input and uses a priority queue to maintain the k tuples with the largest values in a given column. If no predicate P is specified, the best execution plan consists of a sequential scan over table R (or over the smallest-sized covering index, if any is available). First focus is on queries with no filter predicate P, and then how to lift this restriction.
Threshold-Based Algorithms in RDBMS

Threshold-based algorithms such as, for example, TA can be adapted to work in the context of an RDBMS as follows. Indexes are the most widely used mechanism to improve performance in an RDBMS, and adaptation of the TA algorithm utilized in instances of the subject invention is based on such redundant physical structures. Specifically, each autonomous source in the original TA is simulated with suitable index strategies that support the sorted and random access interfaces.

The TA's scoring function is a monotonic aggregate of individual attribute scoring functions. If these attribute scoring functions are not restricted in any way, in general, all tuple values would need to be accessed and sorted by each attribute scoring function before providing the first sorted access. This preprocessing step is expensive and defeats the purpose of TA (i.e., avoiding costly scans over the data). In middleware systems, cost metrics do not include this preprocessing step since it is assumed to be done by the autonomous sources. For this reason, the attribute scoring functions are restricted to those that can be evaluated efficiently by an index structure (i.e., each sorted access should be processed in a constant amount of time).

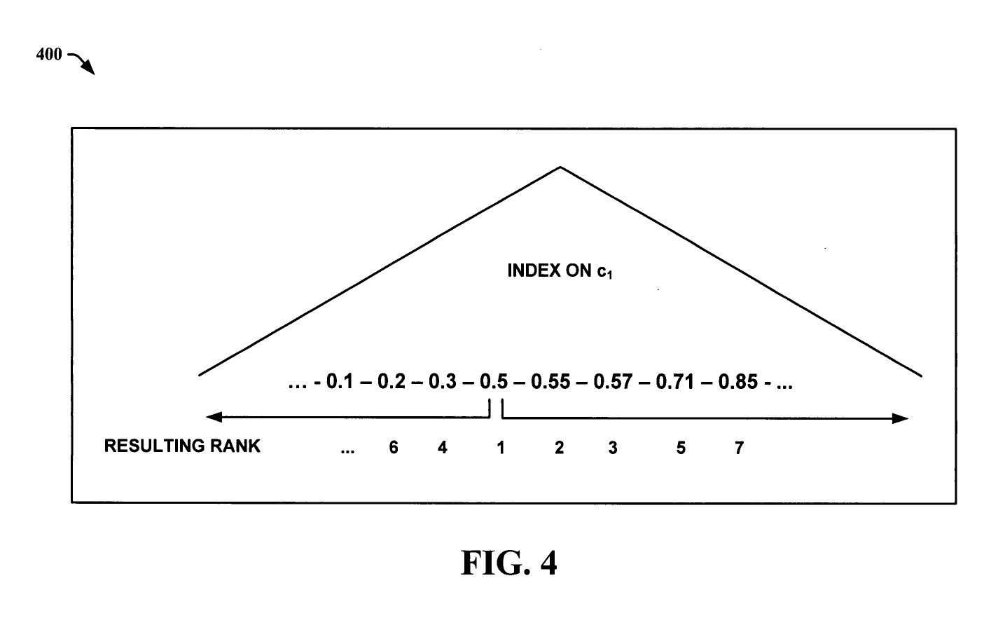

Consider, for example, an attribute scoring function 3·c₁. If an index with leading column c₁ is available, this index can be scanned in descending order to obtain each tuple sorted by 3·c₁ in constant time. As a slightly more complex example, if the scoring function is −(c₁−0.5)² and an index with leading column c₁ is available, the procedure is as follows. Larger scores are assumed to be better, so a negative sign is introduced in −(c₁−0.5)² to first obtain tuples closer to c₁=0.5. In general, the best scores could either be the largest or smallest ones, but those details are omitted here for simplicity. Initially, the index is sought for value 0.5 and all the matches are returned. Then, two pointers are maintained that traverse the index in opposite directions starting at c₁=0.5, and, for each subsequent sorted access, the current tuple from one of the two traversals that is closer to c₁=0.5 is returned (see FIG. 4 which illustrates providing sorted accesses using indexes). One skilled in the art can appreciate that although examples focus on simple functions, the methodology is the same for complex functions as long as they are efficiently supported by indexes, and these complex functions are within the scope of instances of the subject invention as well.

After obtaining a new tuple from each source, TA performs random accesses to the other sources to obtain the remaining attribute scores. There are two differences in this step between the original TA algorithm and the adapted version utilized by instances of the subject invention. First, in an RDBMS, all remaining attribute values can be obtained at once using a single (random) primary index lookup rather than m−1 random accesses. This facilitates pruning of the space of candidate TA-strategies as described infra. Second, if the index providing sorted access is a covering index (i.e., it is defined over all cᵢ columns), a primary index lookup is not needed to obtain the remaining values.

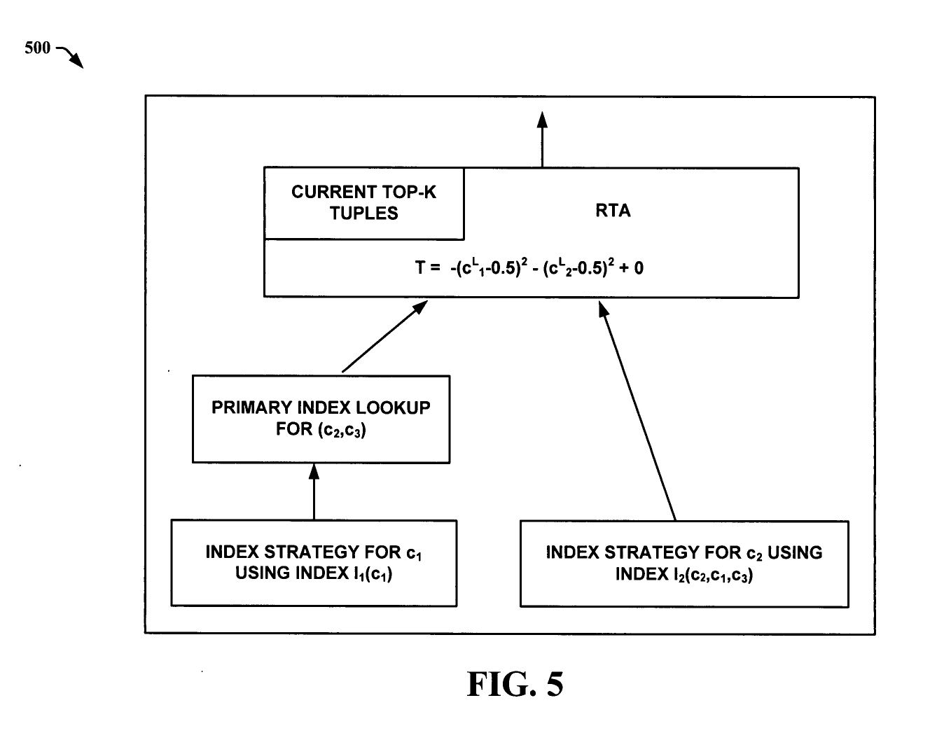

After defining how to provide sorted and random access by using indexes, a piece of logic is needed that ties everything together. A new physical operator, RTA, (for Relational-TA) is defined and is illustrated in FIG. 5 (illustrating a sample threshold-based execution plan). The RTA operator, analogous to the original TA algorithm, (i) retrieves a new tuple from each input in a round robin fashion, (ii) maintains a priority queue with the top-k tuples seen so far, (iii) calculates the threshold value, and (iv) stops when the threshold value is not better than the current top-k value. FIG. 5 shows a sample execution plan for a top-k query with scoring function

$${\sum }_{i = 1}^{3} - {( {c}_{i} - 0.5 )}^{2} .$$

In the example, the index strategy for column c₁ does not use a covering index, and, therefore, primary index lookups are necessary. Because there is no index strategy for attribute c₃, RTA uses, in the threshold formula, the maximum possible score for c₃, which in this case is zero.

Any TA strategy that uses zero and/or one indexes with leading column cᵢ for each attribute cᵢ in the scoring function is a candidate execution plan. The space of candidate TA strategies with respect to the set of available indexes and pruning techniques that reduce the number of alternatives to consider are described infra.

Space of TA Strategies

Suppose that each column cᵢ in the scoring function is associated with the set of indexes that have cᵢ as their leading column. A valid TA strategy can then be obtained by picking zero and/or one indexes from each group. If nᵢ is the number of indexes with leading column cᵢ, the total number of plans is Πᵢ(nᵢ+1)−1. Two simple properties that allow us to reduce the set of candidate indexes are as follows.
Property 1: If there is a covering index I with leading column cᵢ (or there are many covering indexes but I is the smallest-sized of those) and a TA strategy P uses another index I′ for column cᵢ, I′ can be replaced with I to obtain a more efficient strategy.

In fact, a covering index provides all the necessary columns and, therefore, does not require primary index lookups (see, FIG. 5). Since each entry in the covering index is smaller than the corresponding one in the primary index, the number of pages accessed using the covering index is no larger than the number of pages accessed by a non-covering index and the primary index lookups put together. Similarly, if many covering indexes are available, the smallest-sized one accesses the least number of pages. Therefore, the strategy that uses the I is more efficient than any of the alternatives.
Property 2: If there is no covering index with leading column cᵢ, the most efficient plan that uses an index for cᵢ uses the smallest-sized index with leading column cᵢ.

In fact, if no covering index is available for cᵢ, then any index that handles attribute cᵢ would miss at least one attribute, and, therefore, would require one (and only one) primary index lookup to obtain the remaining attribute scores. The smallest-sized index with leading column cᵢ guarantees that the index scan is as efficient as possible, and independently of the index used for cᵢ, the subsequent operators are the same. Therefore, the smallest-sized index with leading column cᵢ results in the most efficient execution.

Using both properties, the space of candidate TA strategies is reduced, for each attribute cᵢ in the scoring function, to either zero or the best index for cᵢ. In absence of additional information, every possible plan is optimal for some data distribution. Consider TABLE 3 infra and a scoring function

$$F = {\sum }_{i = 1}^{m} {c}_{i} .$$

TABLE 3
Data For Scoring Function

| id | c₁ | c₂ | c₃ | . . . | cₙ | cₙ₊₁ | . . . | cₘ |
|---|---|---|---|---|---|---|---|---|
| 1 | 1 | 0 | 0 | . . . | 0 | 0 | . . . | 0 |
| 2 | 0 | 1 | 0 | . . . | 0 | 0 | . . . | 0 |
| 3 | 0 | 0 | 1 | . . . | 0 | 0 | . . . | 0 |
| . . . | . . . | . . . | . . . | . . . | . . . | . . . | . . . | . . . |
| n | 0 | 0 | 0 | . . . | 1 | 0 | . . . | 0 |
| n + 1 | 0.9 | 0.9 | 0.9 | . . . | 0.9 | 0 | . . . | 0 |
| n + 2 | 0.9 | 0.9 | 0.9 | . . . | 0.9 | 0 | . . . | 0 |
| . . . | . . . | . . . | . . . | . . . | . . . | . . . | . . . | . . . |

Assuming that the table is of size N, the top-k tuples (for k<N−n) will have score 0.9n. Suppose that indexes are used for columns c₁ through cₙ. In this case, after k+n iterations the top-k values will have score 0.9n, and the threshold would also be 0.9n (because the maximum score for all columns without indexes is zero). Therefore, after k+n iterations the algorithm would terminate. Now, if indexes over any subset of {c₁, c₂, . . . ,cₙ} are utilized, the threshold value after any number of iterations beyond n would be 0.9n₁+1 (n−n₁) which is larger than the current top-k value 0.9n. Therefore, this strategy would require reading all N tuples from such indexes and would in general be more expensive than the previous one. Finally, any plan that uses indexes from cₙ₊₁ through cₘ will be more expensive than if those indexes are not used, because they do not reduce the threshold, and, therefore, the number of iterations remains the same while the number of index sorted accesses increase. Thus, an optimal TA strategy uses indexes just for c₁ through cₙ. But those columns are arbitrary, so for any candidate TA strategy, there will be a data distribution for which it is optimal.

Depending on the data distribution, the optimal TA strategy can be worse than the scan-based alternative. A cost model can be developed that not only allows for comparisons of candidate TA strategies, but also facilitated to determine whether the optimal TA strategy is expected to be more efficient than the scan-based alternative.

Cost Model

The systems and methods provided by instances of the subject invention that allow application of TA strategies to an RDBMS are composed of smaller pieces that are well-known and implemented in current relational systems. However, instances of the subject invention employ the smaller pieces for different purposes. Any execution of TA consists of a series of sorted accesses (i.e., index traversals), a series of random accesses (i.e., optional primary index lookups in absence of covering indexes), and some computation to obtain scores, threshold values, and priority queue maintenance (i.e., scalar computation and portions of the partial-sort operator). If a given TA strategy requires D iterations to finish (i.e., D sorted accesses over each attribute), the cost of its execution plan is estimated as follows in Equation 1:

$$Cost = D \cdot {T}_{C} \cdot ( {\sum }_{1 \leq i \leq m , \\ {c}_{i} usesindex \\ strategy} {T}_{{S}_{i}} + {\sum }_{l \leq i \leq m , \\ {c}_{i} usesnon \\ coveringindex} {T}_{L} ) \qquad ( Eq . 1 )$$

where T_{C} represents the cost of maintaining the priority queue and calculating scores and threshold values, T_{S}_{ᵢ} is the cost of a sorted access using the index for attribute cᵢ, and T_{L} is the cost of a primary index lookup. Exploitation of this formula to further reduce the candidate plans to consider during optimization is described infra.

Consider two TA strategies T₁ and T₂, and suppose that the set of attributes that T₁ handles using indexes is a subset of that of T₂. Let D₁ and D₂ be the number of iterations required by T₁ and T₂, respectively, to obtain the top-k tuples. The cost of T₁ is then estimated as D₁·γ₁ where D₁ is the number of iterations that T₁ requires and γ₁ represents the cost per iteration (see the cost formula supra). Similarly, the cost of T₂ is estimated as D₂·γ₂. A property derived from the TA algorithm is that D₁≧D₂ The reason is that T₁ has less information to calculate threshold values, and, therefore, requires more iterations to make the threshold fall below the current top-k score. At the same time, γ₁≦γ₂ because, at each iteration, T₁ makes sorted and possibly random accesses to a subset of the indexes present in T₂. Thus, in general, either T₁ or T₂ can be the better alternative. Now consider strategy T₃, whose set of indexes includes that of T₁, and it is included in that of T₂. Using similar arguments as above, the cost of T₃ can be guaranteed to be at least D₂·γ₁. Therefore, if the best strategy found so far is cheaper than D₂·γ₁, all intermediate strategies like T₃ can be omitted from consideration.

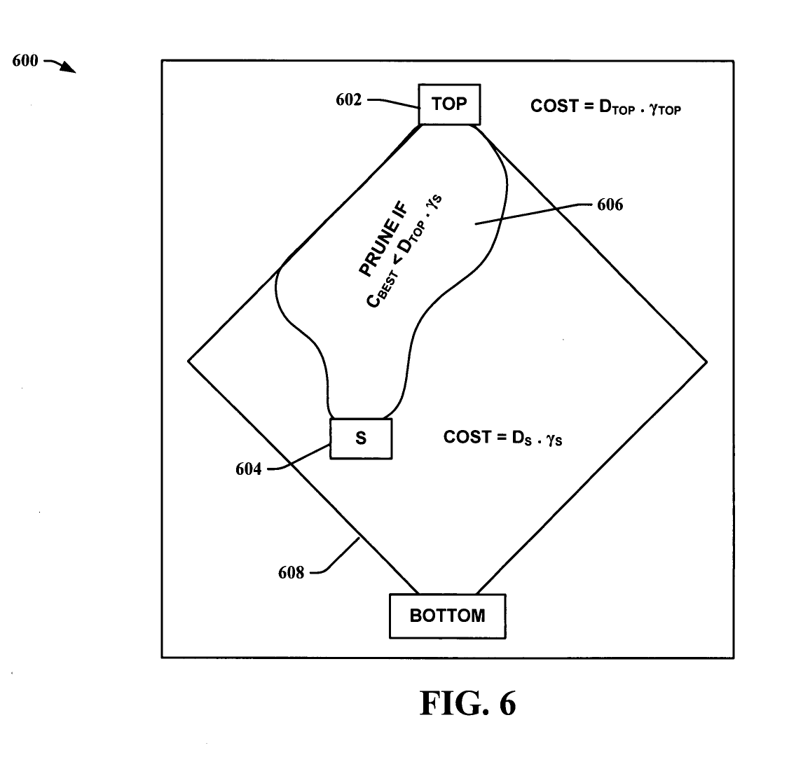

In practice, this property can be utilized as follows. FIG. 6 shows a lattice 608 on the subset of indexes used by threshold-based strategies. Suppose that the cost of strategy Top 602, which uses indexes for all columns, is evaluated initially, and D_{Top} is obtained as the estimated number of iterations. Assume that the best strategy found so far has a cost equal to C_{best}. Whenever a new strategy S 604 is considered, the cost per iteration γ_{S} can be calculated. If D_{Top}·γ_{S}>C_{best}, all threshold-based strategies that include S's indexes 606 can be safely omitted from consideration.

In the above cost formula, all components can be accurately estimated reusing the cost model of the database optimizer, except for the number of iterations D. This value depends on the data distribution and crucially determines the overall cost of TA. The estimate of the expected number of iterations D for a given TA strategy is described infra.

Estimating TA Complexity

As described supra, in order to estimate the cost of any given TA strategy, the number of iterations D that would execute such strategy before the threshold value falls below the current (and therefore final) top-k score needs to be approximated. In other words, if sₖ denotes the score of the top-k tuple and T(d) the value of the threshold after d iterations, D, the minimum value of d such that T(d)≦sₖ needs to be estimated. D is determined by approximating the two sides of this inequality. sₖ, the score of the top-k tuple, is first approximated. Then, the minimum value d after which T(d) is expected to fall below sₖ is estimated.

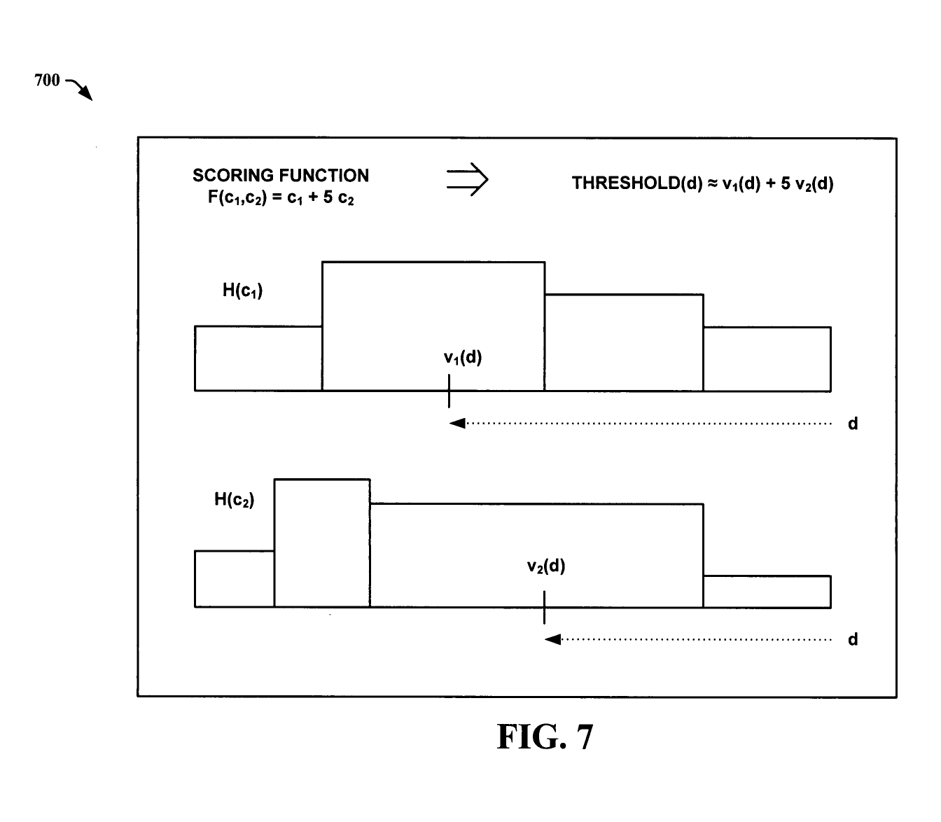

Assume that sₖ, the score of the top-k tuple, is already estimated. To approximate the number of iterations after which the threshold value falls below sₖ, single-column histograms are utilized. In fact, an important observation regarding TA is that it manipulates single-dimensional streams' of data returned by the autonomous sources. Thus, TA can be accurately simulated over histograms very efficiently, at bucket granularity. FIG. 7 shows a simple example for a scoring function F(c₁,c₂)=c₁+5·c₂. If the top-k score sₖ is equal to, for example, 0.95, the histogram buckets can be walked starting from the right-most bucket, and the minimum number D can be obtained for which the threshold calculated with the values of the top-D tuples from each histogram is smaller than sₖ. For simple attribute scoring functions, this procedure requires splitting buckets and using interpolation in a similar way as when joining histograms for cardinality estimation. For complex attribute scoring functions, binary search over the histogram domains are utilized to find D, which is also very efficient.

Estimating the score sₖ of the top-k tuple is more complex. The difficulty resides on the fact that this is a truly multidimensional problem, and, therefore, relying on single-dimensional approximations (like traditional histograms) can easily result in excessive approximation errors. For that reason, multidimensional data synopses need to be utilized to estimate sₖ values. Multidimensional histograms and samples can be considered as alternative synopses. However, samples were determined to be a better alternative than histograms. The reason is that multidimensional samples scale better with an increasing number of dimensions. In fact, multidimensional histograms do not provide accurate estimations beyond five to six attributes (e.g., see N. Bruno, S. Chaudhuri, and L. Gravano; STHoles: A multidimensional workload-aware histogram; In Proceedings of the ACM International Conference on Management of Data (SIGMOD); 2001; and D. Gunopulos, et al.; Approximating multi-dimensional aggregate range queries over real attributes; In Proceedings of the ACM International Conference on Management of Data (SIGMOD); 2000), and, therefore, a large number of at most 5-dimensional histograms to cover all attribute combinations in wide tables would need to be built. Contrary to previous work in approximate query processing, the precomputed samples of instances of the subject invention are very small. These samples are loaded and manipulated as part of query optimization, and, therefore, are roughly of the size of other database statistics. In other words, single-column projection of the precomputed sample is roughly as large as a single-column histogram in the database system. For example, a sample size of 1,000 tuples can be utilized, independent of the size of the underlying table.

To estimate the value sₖ from the precomputed sample, the score of each tuple in the sample is first computed and the scores are ordered by decreasing score value. sₖ is then estimated using interpolation. If the original table contains N tuples and the sample contains S tuples, the probability that the top-r_{S} element in the sample is the top-r_{N} element in the original data, denoted P(r_{S} is r_{N}), is given by Equation 2:

$$P ( {r}_{S} is {r}_{N} ) = \frac{( \begin{matrix}{r}_{N} - 1 \\ {r}_{S} - 1\end{matrix} ) \cdot ( \begin{matrix}N - {r}_{N} \\ S - {r}_{S}\end{matrix} )}{( \begin{matrix}N \\ S\end{matrix} )} \qquad ( Eq . 2 )$$

and, therefore, the expected rank in the original table of the top-r_{S} tuple in the sample, denoted E(r_{S}), is given by Equation 3:

$$E ( {r}_{S} ) = {\sum }_{i} \frac{( \begin{matrix}i - 1 \\ {r}_{s} - 1\end{matrix} ) \cdot ( \begin{matrix}N - i \\ S - {r}_{S}\end{matrix} )}{( \begin{matrix}N \\ S\end{matrix} )} \cdot i = {r}_{S} \cdot \frac{N + 1}{S + 1} \qquad ( Eq . 3 )$$

Using this equation, the two consecutive samples in descending order of score that are expected to cover the top-k element in the original data are located and their respective scores are interpolated to obtain an approximation of sₖ. The estimation algorithm can then be summarized as follows:
Using a precomputed small sample obtain sₖ, the approximate score of the top-k tuple.
Using single-column histograms, obtain the minimum value D that results in a threshold value below sₖ.
Evaluate the cost function using D as the approximation of the number of iterations.
   This algorithm can be used for arbitrary TA strategies by using only the histograms that correspond to columns that are handled using indexes in the query plan (the remaining columns simulate TA by using the maximum possible score). On the other hand, the above algorithm presents some problems for the class of top-k queries such as those described and addressed infra.
   Addressing Small k Values

The algorithm described supra has a drawback in most interesting query instances. The problem is that only around a thousand tuples are used in the precomputed sample, and, therefore, it is always working on the tails of probability distributions. For instance, suppose that a data set contains 1 million tuples, and a sample of size 1,000 is utilized. In this case, the top scoring tuple in the sample is expected to rank at position 1,000,001/1,001≈999 in the original table. This means that for any top-k query with k<999 (i.e., a very common scenario), sₖ would be smaller than the top tuple in the sample. Extrapolation is then needed to approximate the top-k score, generally resulting in large approximation errors.

An alternative approximation mechanism that works in the space of iterations of TA rather than on the space of object scores is described. First, obtain the top-k′ scores from the precomputed sample where k′ is a small constant number (for example, use k′=10). If the original table contains N tuples and the sample size is S, the top-k′ scores in the sample are expected to rank in the original table at positions

$$i \cdot \frac{N + 1}{S + 1} for i = 1 … 10.$$

Then, calculate as before the approximated number of iterations for each such score and obtain a set of pairs

$$\{ ( i \cdot \frac{N + 1}{S + 1} ,$$

expected iterations for

$$i \cdot \frac{N + 1}{S + 1} ) , i = 1 … 10 \} .$$

Finally, fit the best curve that assigns expected number of iterations to obtain top-K values for arbitrary values of K, and evaluate this function at K=k. The obtained value is utilized as the estimated number of iterations to obtain the top-k elements. The revised algorithm can be summarized as follows:
Using a precomputed small sample, obtain the top-10 scores that are expected to rank in the original data at positions

$$\frac{N + 1}{S + 1} , … , \frac{10 \cdot ( N + 1 )}{S + 1} .$$
Using single-column histograms, obtain the expected number of iterations for each score.
Find the best curve that approximate the “number of iterations” function and evaluate it in k obtaining D.
Evaluate the cost function using D as an approximation for the number of iterations.

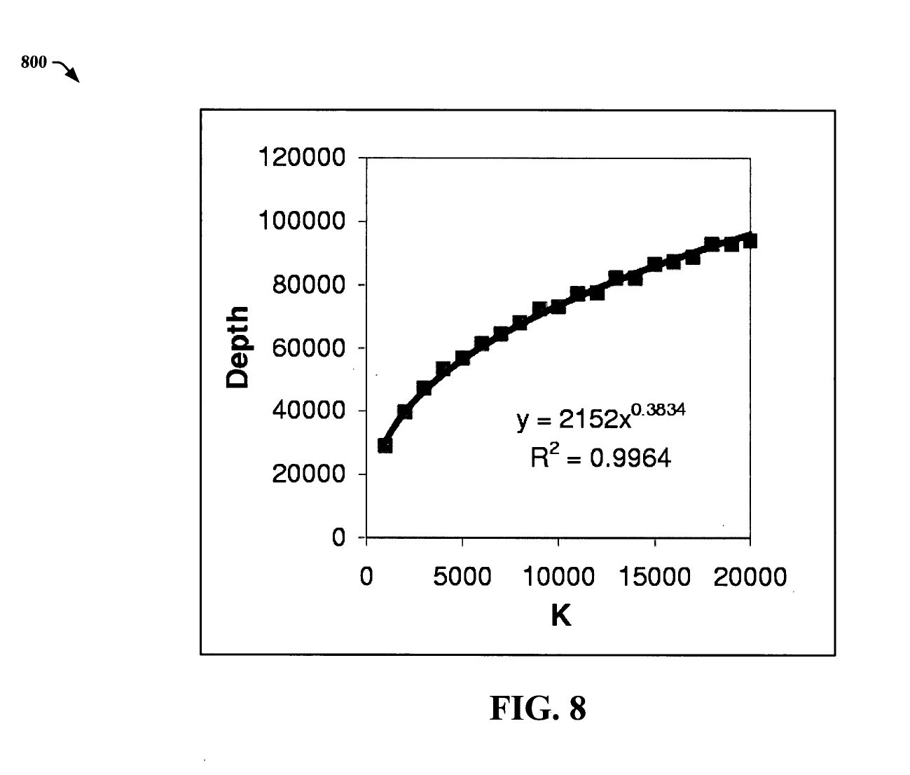

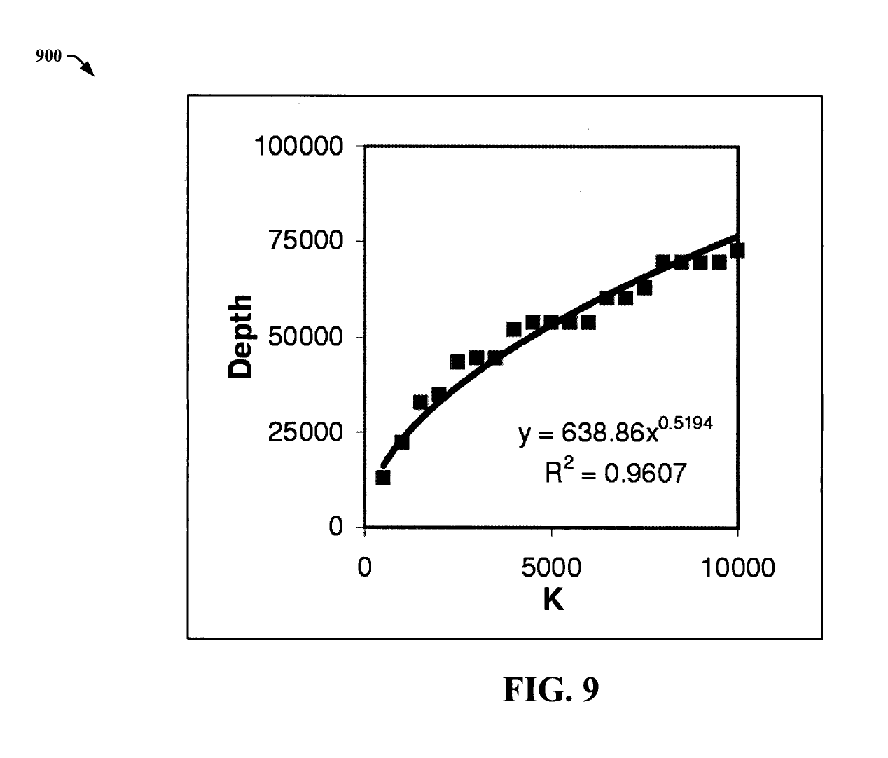

An important decision is which model function to use to approximate number of iterations for arbitrary values of k. The simplest approach is to use linear regression, but many others are possible and are within the scope of the subject invention. For example, a power function D(k)=a·e^{b-k} where a and b are parameters that minimize the square root error can be utilized. FIGS. 8 and 9 show two executions of TA as an example. The exact number of iterations for varying k values is obtained and then the best power function is calculated that fits the data. For FIG. 8, the real data set cover was utilized, and a scoring function of the form

$${\sum }_{i = 1}^{3} - {( {c}_{i} - {v}_{i} )}^{2} ,$$

where vᵢ are random values in the data domain. For FIG. 9, a two dimensional Zipfian distribution was utilized, and the scoring function w₁·c₁+w₂·c₂, where 0<wᵢ≦1 are random numbers. Power laws can approximate the number of iterations with reasonable accuracy. Of course, this is just an approximation as the true underlying function depends on the data distribution and, in general, can have any (monotonically increasing) behavior. However, power laws resulted in the best overall accuracy for a wide class of data distributions and scoring functions (Note that Fagin introduces an earlier algorithm to obtain top-k answers with a probabilistic access cost that follows a power law in terms of k.).

A second difficulty of techniques utilized by instances of the subject invention is due to the limited sample size. As described supra, the expected rank in the data distribution of the i-th highest ranked element in the sample is

$$i \cdot \frac{N + 1}{S + 1} .$$

The accuracy of that estimation is analyzed for the special case of i=1 (i.e., how close to

$$\frac{N + 1}{S + 1}$$

in the original data set is the rank of the top object in the sample). The variance of the rank in the original table of the top tuple in the sample, denoted V(1_{S}), is given by Equation 4:

$$\begin{matrix}V ( {1}_{S} ) = {\sum }_{i} \frac{( \begin{matrix}N - i \\ S - 1\end{matrix} )}{( \begin{matrix}N \\ S\end{matrix} )} \cdot {( \frac{N + 1}{S + 1} - i )}^{2} \\ = \frac{S ( N + 1 ) ( {N}^{2} - NS - 3 N + {S}^{2} + 2 )}{{( S + 1 )}^{2} ( S + 2 ) ( N - S + 1 )}\end{matrix} \qquad ( Eq . 4 )$$

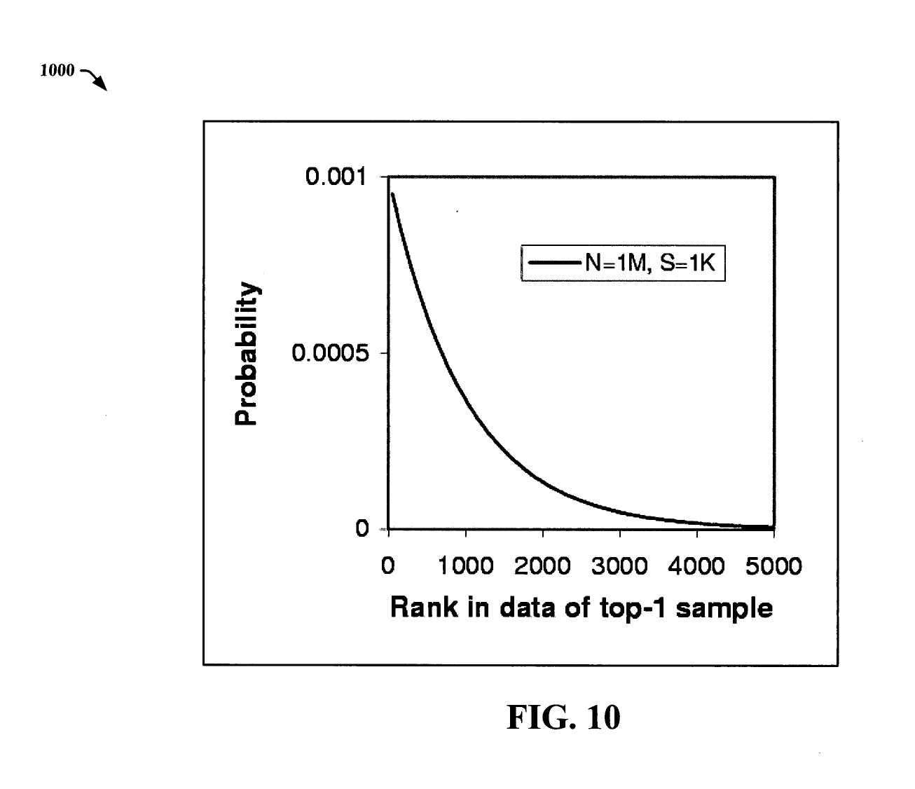

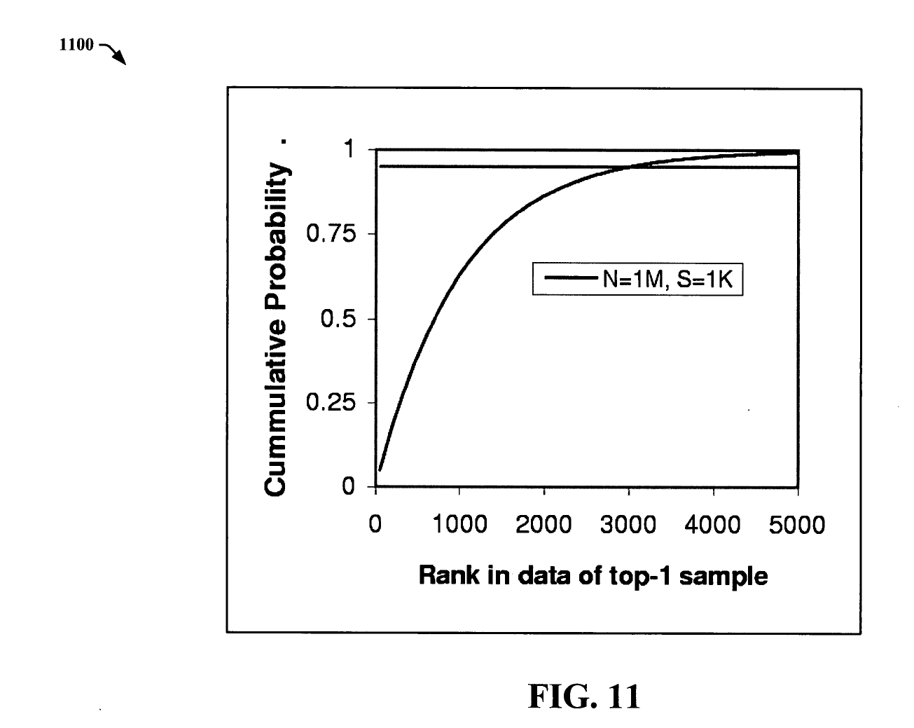

which is approximately (N+1/S+1)² if N>>S. In other words, the standard deviation of the rank in the original relation of the top object in the sample is as large as the expected rank itself. FIGS. 10 and 11 illustrate this fact for a sample table with 1 million tuples and a sample of size 1,000. In this case, the rank in the original table of the highest ranked sample is expected to be around 999. FIG. 10 shows the probability distribution of such rank. 999 is not even the most frequent value, and the probability distribution is rather flat. FIG. 11 shows the cumulative probability distribution and the fact that with 95% confidence the actual rank of the top ranked sample can be anywhere between 1 and 3000 (a range that is three times as large as the actual expected value).

However, the ultimate goal of the estimation procedure is not to establish highly accurate values for the number of iterations, but to help the optimizer choose a good execution plan. Therefore, if the actual estimated cost of the best TA strategy is significantly larger or smaller than that of the scan-based alternative, moderate variations in the estimation of cost will not change the optimal plan from being chosen. When the two numbers are close, though, there is a larger chance that errors in estimation will propagate to the selection of plans.

Instances of the subject invention can also employ an additional small “safety” factor as follows. The procedure to estimate the cost of any TA strategy uses some approximations that are intrinsically not extremely accurate. On the other hand, the cost estimation for a scan alternative can be estimated very accurately. As a conservative measure, only choose a TA strategy if it is cheaper than α times the cost of an alternative scan, where 0<α≦1 (e.g., use α=0.5—this number can in general reflect the degree of confidence that is required before executing a TA strategy). Choose a TA strategy only if confident enough that it will be cheaper than the scan-based alternative. It is possible to choose the scan-based alternative even though a TA strategy was indeed the optimal plan, but this is an expected consequence of implementing a conservative approach.

Filter Predicates

Previously, there was an assumption that no filter predicate was restricting the set of tuples that qualify to be part of the answer. That restriction can be relaxed as follows. Consider the general query in TABLE 4:

TABLE 4
General SQL Query

SELECT TOP(k) cl, ..., cm
FROM R
WHERE P
ORDER BY F(sₗ(cl), ..., sₘ(cm)) DESC

where P is an arbitrary predicate over the columns of R. Evaluation of such queries and estimations of their execution costs are described infra.
Execution Alternatives

A straightforward extension of TA to handle arbitrary filter predicates is as follows. In FIG. 5, the main components of a typical TA strategy are shown. The premise is to add a small piece of logic in the RTA operator, which evaluates predicate P before considering the addition of the current object to the set of top-k tuples. If the current tuple does not satisfy P, it is dropped from consideration. The calculation of the threshold, however, considers all tuples whether they satisfy P or not. This execution strategy is feasible if RTA receives input tuples that additionally reference all the columns required to evaluate P. If the current tuple was obtained from an index strategy followed by a primary index lookup, then all relevant columns are already present. Otherwise, if a covering index was used, an additional index lookup is performed to obtain the remaining columns. Of course, if the covering index additionally contains all columns referenced by P, then there is no need to do any primary index lookup. All the pruning considerations are similar to the example discussed supra.

If the predicate P satisfies certain properties, there is another alternative that can be more efficient, especially if P is selective. Consider the following query in TABLE 5:

TABLE 5
SQL Query

SELECT TOP(10) a, b, c
FROM R
WHERE d=10
ORDER BY a+b+c DESC

and suppose that an index on column d is available. In that case, the selection condition can be pushed into the order by clause and transform the query above as follows in TABLE 6:

TABLE 6
Transformed SQL Query

| SELECT TOP(k) a, b, c | | | | |
|---|---|---|---|---|
| FROM R | | | | |
| | | 0 | if d=10 | |
| ORDER BY a+b+c+ | {close oversize brace} | | | DESC |
| | | −∞ | otherwise | |

Thus, if there are at least k tuples for which d=10, both queries are equivalent (otherwise, all the tuples with score equal to −∞ need to be discarded from the latter query). In this case, a query with a filter predicate is reduced to an equivalent one that does not have it. Also, the index on column d can be used to return all tuples that satisfy the filter predicate before any tuple that does not satisfy it (after the first tuple that not satisfying P is returned, the threshold value drops below the current top-k score and execution terminates). In general, this alternative TA strategy can be utilized by pushing to the scoring function all predicates that can be efficiently retrieved using indexes.
Cost Estimation

A key observation to estimate the cost of the extended strategies discussed above is that introducing filter predicates does not change TA's early termination condition, which is “stop after the threshold falls below the score of the current (and final) top-k object.” Therefore, the procedure explained supra can also be used in this scenario. The difference is that predicate P needs to be applied initially to the precomputed sample so that only tuples are considered that satisfy the filter predicate. Note, however, that the accuracy of this method will diminish since the effective sample used for estimation is even smaller than the original one.

Alternatives

There are other enhancements to the main algorithm that can speed up the overall execution of a top-k query. For instance, TA uses bounded buffers and only stores the current top-k objects in a priority queue. While this is important to guarantee that the algorithm will not run out of memory during its execution, some objects might be looked up in the primary index multiple times if they are not part of the top-k objects (once each time an object is retrieved from a source). Space can be traded for time—keeping a hash table of all objects already seen. If an object is retrieved using sorted access, and it is already in the hash table, it is not processed again (saving a primary index lookup).

Another optimization technique is to relax the requirement that sorted accesses are done in a round-robin fashion. In general, each source can be accessed at different rates and tuples retrieved more often from those sources that contribute more to decreasing the threshold value. Conversely, if the score distribution of an attribute is close to uniform, the rate at which new tuples are requested can be decreased from that source. It is fairly straightforward to show that a strategy that performs sorted accesses at different rates can be better than any alternative strategy that proceeds in lockstep. It is interesting to note that for fixed, but different access rates to the sources, the estimation techniques described supra that utilizes single-column histograms can be applied with almost no changes. In this case, the minimum values {D₁, . . . ,Dₘ} for which the threshold value calculated with the top-Dᵢ value is obtained for each attribute cᵢ that is expected to fall below the top-k score.

Finally, there are alternatives to further avoid primary index lookups. Consider a top-k query over attributes a, b, and c, and suppose that a composite non-covering index on (a,b) is utilized to process attribute a. For each tuple retrieved from the index, it is first assumed that the value of c is as large as possible. If the resulting score calculated in that way is still smaller than the current top-k score, the tuple is discarded without performing a primary index lookup. Although this idea is at first glance straightforward, it carries important implications for optimization. Specifically, the pruning techniques described supra need to be refined to work in this scenario. For example, if indexes over both (a) and (a, b) are available, the pruning techniques would not consider (a, b) (see Property 2 supra), which can be the best alternative when this optimization is used.

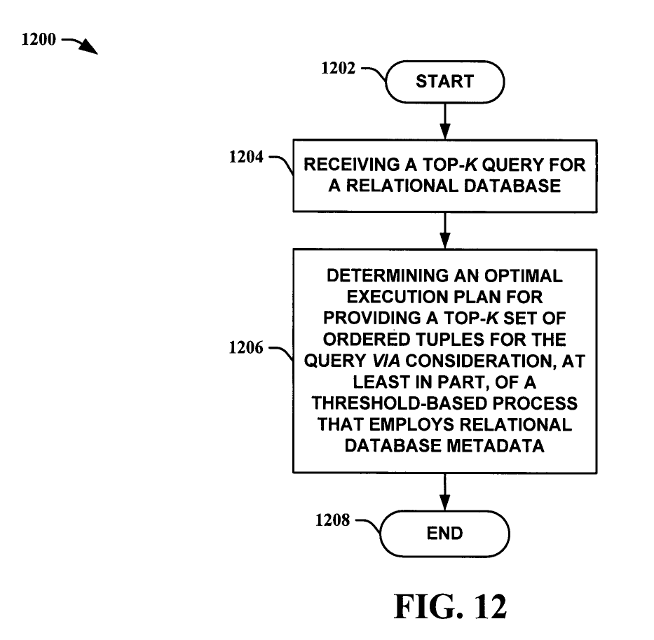

In view of the exemplary systems shown and described above, methodologies that may be implemented in accordance with the subject invention will be better appreciated with reference to the flow charts of FIGS. 12-14. While, for purposes of simplicity of explanation, the methodologies are shown and described as a series of blocks, it is to be understood and appreciated that the subject invention is not limited by the order of the blocks, as some blocks may, in accordance with the subject invention, occur in different orders and/or concurrently with other blocks from that shown and described herein. Moreover, not all illustrated blocks may be required to implement the methodologies in accordance with the subject invention.

The invention may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the subject invention.

In FIG. 12, a flow diagram of a method 1200 of facilitating query optimization in accordance with an aspect of the subject invention is shown. This method 1200 can include, but is not limited to, methods that utilize it 1200 as a facilitating consideration method by traditional optimizers to further enhance existing top-k query systems and the like and/or as a stand-alone method for a top-k query optimizer. The method 1200 starts 1202 by receiving a top-k query for a relational database 1204. An optimal execution plan for providing a top-k set of ordered tuples for the query is then determined via consideration, at least in part, of a threshold-based process that employs relational database metadata 1206, ending the flow 1208.

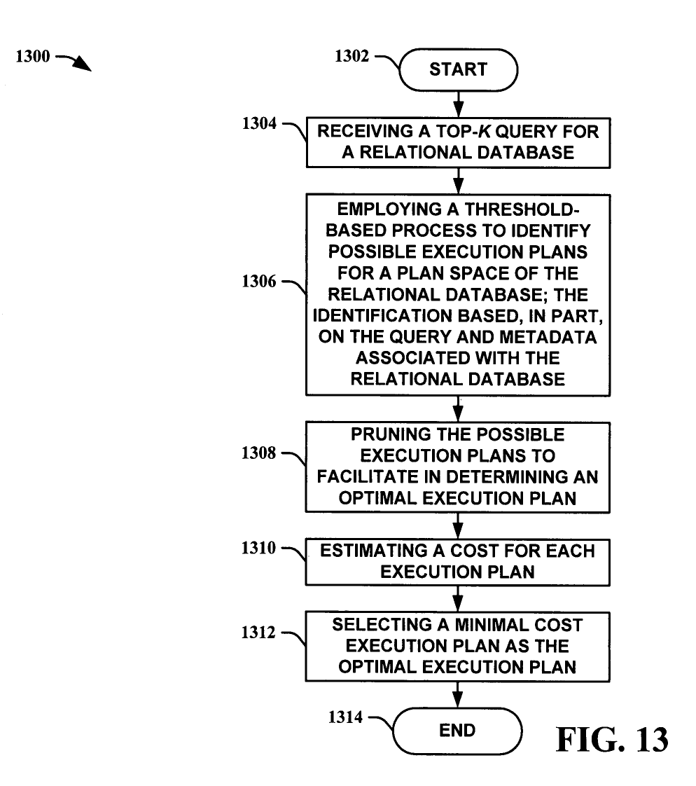

Turning to FIG. 13, another flow diagram of a method 1300 of facilitating query optimization in accordance with an aspect of the subject invention is depicted. This method 1300 can include, but is not limited to, methods that utilize it 1300 as a facilitating consideration method by traditional optimizers to further enhance existing top-k query systems and the like and/or as a stand-alone method for a top-k query optimizer. The method 1300 starts 1302 by receiving a top-k query for a relational database 1304. Execution plans for a plan space of the relational database are then identified via employment of a threshold-based process where the identification is based, at least in part, on the top-k query and metadata associated with the relational database 1306. The metadata can include, but is not limited to, relational structure of a relational database and the like such as, for example, indexes.

Possible execution plans are then pruned to facilitate in determining an optimal execution plan 1308. The pruning can occur in advance and/or simultaneously to the enumeration of the plan space. In one instance of the subject invention, the pruning can be an optional step that is not required to be performed at this stage. Cost for each execution plan of the possible execution plans is then estimated 1310. A minimal cost execution plan is then selected as the optimal execution plan 1312, ending the flow 1314. In other instances of the subject invention, the selection of the minimal cost execution plan is further compared against traditional query optimizing techniques to determine the optimal execution plan. Thus, the optimal execution plan might not be the minimal cost threshold-based execution plan, but, for example, might be a sequential scan-based execution plan with a lower cost. This allows instances of the subject invention to integrate with existing systems to provide substantial efficiency enhancements when applicable without degrading performance of the traditional processes otherwise.

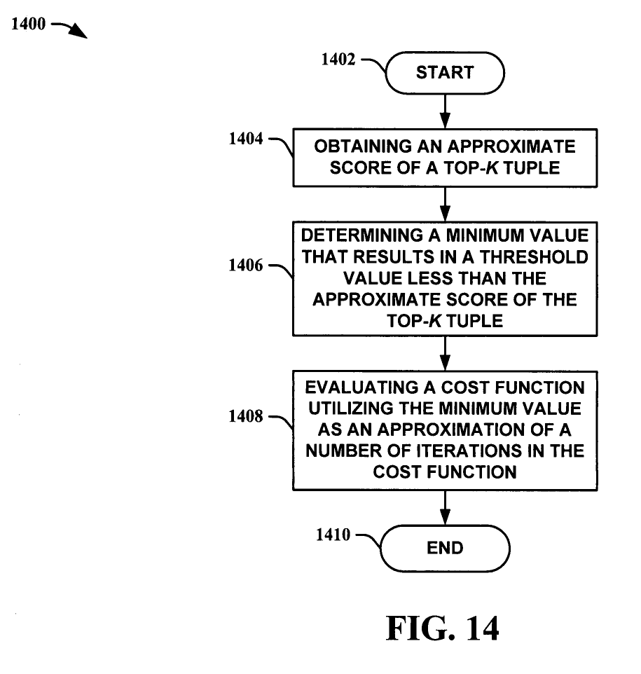

Looking at FIG. 14, a flow diagram of a method 1400 of estimating an execution plan cost in accordance with an aspect of the subject invention is illustrated. The method 1400 starts 1402 by obtaining an approximate score of a top-k tuple 1404. For example, the approximate score sₖ of a top-k tuple can be determined utilizing a sample process. To estimate the value sₖ from the precomputed sample, the score of each tuple in the sample is first computed, and the scores are then ordered by decreasing score value. sₖ is then estimated using interpolation. If the original table contains N tuples and the sample contains S tuples, the probability that the top-r_{S} element in the sample is the top-r_{N} element in the original data, denoted P(r_{S} is r_{N}), is given by Equation 2:

$$P ( {r}_{S} is {r}_{N} ) = \frac{( \begin{matrix}{r}_{N} - 1 \\ {r}_{S} - 1\end{matrix} ) \cdot ( \begin{matrix}N - {r}_{N} \\ S - {r}_{S}\end{matrix} )}{( \begin{matrix}N \\ S\end{matrix} )} \qquad ( Eq . 2 )$$

and, therefore, the expected rank in the original table of the top-r_{S} tuple in the sample, denoted E(r_{S}), is given by Equation 3:

$$E ( {r}_{S} ) = {\sum }_{i} \frac{( \begin{matrix}i - 1 \\ {r}_{S} - 1\end{matrix} ) \cdot ( \begin{matrix}N - i \\ S - {r}_{S}\end{matrix} )}{( \begin{matrix}N \\ S\end{matrix} )} \cdot i = {r}_{S} \cdot \frac{N + 1}{S + 1} \qquad ( Eq . 3 )$$

Using this equation, the two consecutive samples in descending order of score that are expected to cover the top-k element in the original data are located, and their respective scores are interpolated to obtain an approximation of sₖ.

A threshold value that is less than the approximate score of the top-k tuple is then determined 1406. For example, to approximate the number of iterations after which the threshold value falls below sₖ, single-column histograms can be utilized. Threshold-based processes manipulate single-dimensional streams of data returned by autonomous sources. Thus, threshold-based processes can be accurately simulated over histograms very efficiently, at bucket granularity. (see e.g., FIG. 7 for a simple example with a scoring function F(c₁,c₂)=c₁+5·c₂). If a top-k score sₖ is equal to, for example, 0.95, the histogram buckets can be walked starting from the right-most bucket, and the minimum number D can be obtained for which the threshold calculated with the values of the top-D tuples from each histogram is smaller than sₖ. For simple attribute scoring functions, this procedure requires splitting buckets and using interpolation in a similar way as when joining histograms for cardinality estimation. For complex attribute scoring functions, binary search over the histogram domains can be utilized to find D, which is also very efficient.

A cost function utilizing the minimum value as an approximation of a number of iterations in the cost function is then evaluated 1408, ending the flow 1410. For example, if a given threshold-based strategy requires D iterations to finish (i.e., D sorted accesses over each attribute), the cost of its execution plan can be estimated as follows in Equation 1:

$$Cost = D \cdot {T}_{C} ( {\sum }_{{1 \leq i \leq m ,}_{{{c}_{i} usesindex}_{strategy}}} {T}_{{S}_{i}} + {\sum }_{{1 \leq i \leq m ,}_{{{c}_{i} usesnon}_{coveringindex}}} {T}_{L} ) \qquad ( Eq . 1 )$$

where T_{C} represents the cost of maintaining the priority queue and calculating scores and threshold values, T_{S}_{ᵢ} is the cost of a sorted access using the index for attribute cᵢ, and T_{L} is the cost of a primary index lookup. Cost functions can be employed to further reduce possible execution plans during top-k query optimization. Additional variations of this instance of the subject invention are described supra as well.

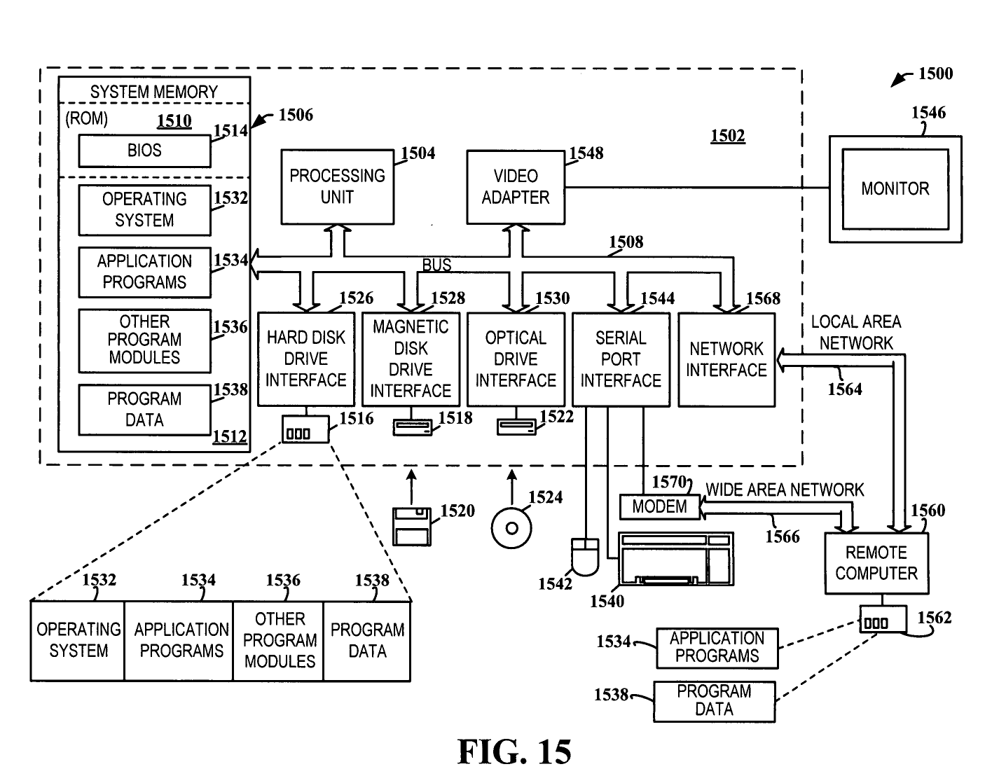

In order to provide additional context for implementing various aspects of the subject invention, FIG. 15 and the following discussion is intended to provide a brief, general description of a suitable computing environment 1500 in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 15, an exemplary system environment 1500 for implementing the various aspects of the invention includes a conventional computer 1502, including a processing unit 1504, a system memory 1506, and a system bus 1508 that couples various system components, including the system memory, to the processing unit 1504. The processing unit 1504 may be any commercially available or proprietary processor. In addition, the processing unit may be implemented as multi-processor formed of more than one processor, such as may be connected in parallel.

The system bus 1508 may be any of several types of bus structure including a memory bus or memory controller, a peripheral bus, and a local bus using any of a variety of conventional bus architectures such as PCI, VESA, Microchannel, ISA, and EISA, to name a few. The system memory 1506 includes read only memory (ROM) 1510 and random access memory (RAM) 1512. A basic input/output system (BIOS) 1514, containing the basic routines that help to transfer information between elements within the computer 1502, such as during start-up, is stored in ROM 1510.

The computer 1502 also may include, for example, a hard disk drive 1516, a magnetic disk drive 1518, e.g., to read from or write to a removable disk 1520, and an optical disk drive 1522, e.g., for reading from or writing to a CD-ROM disk 1524 or other optical media. The hard disk drive 1516, magnetic disk drive 1518, and optical disk drive 1522 are connected to the system bus 1508 by a hard disk drive interface 1526, a magnetic disk drive interface 1528, and an optical drive interface 1530, respectively. The drives 1516-1522 and their associated computer-readable media provide nonvolatile storage of data, data structures, computer-executable instructions, etc. for the computer 1502. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 1500, and further that any such media may contain computer-executable instructions for performing the methods of the subject invention.

A number of program modules may be stored in the drives 1516-1522 and RAM 1512, including an operating system 1532, one or more application programs 1534, other program modules 1536, and program data 1538. The operating system 1532 may be any suitable operating system or combination of operating systems. By way of example, the application programs 1534 and program modules 1536 can include a query optimizer scheme in accordance with an aspect of the subject invention.

A user can enter commands and information into the computer 1502 through one or more user input devices, such as a keyboard 1540 and a pointing device (e.g., a mouse 1542). Other input devices (not shown) may include a microphone, a joystick, a game pad, a satellite dish, a wireless remote, a scanner, or the like. These and other input devices are often connected to the processing unit 1504 through a serial port interface 1544 that is coupled to the system bus 1508, but may be connected by other interfaces, such as a parallel port, a game port or a universal serial bus (USB). A monitor 1546 or other type of display device is also connected to the system bus 1508 via an interface, such as a video adapter 1548. In addition to the monitor 1546, the computer 1502 may include other peripheral output devices (not shown), such as speakers, printers, etc.

It is to be appreciated that the computer 1502 can operate in a networked environment using logical connections to one or more remote computers 1560. The remote computer 1560 may be a workstation, a server computer, a router, a peer device or other common network node, and typically includes many or all of the elements described relative to the computer 1502, although for purposes of brevity, only a memory storage device 1562 is illustrated in FIG. 15. The logical connections depicted in FIG. 15 can include a local area network (LAN) 1564 and a wide area network (WAN) 1566. Such networking environments are commonplace in offices, enterprise-wide computer networks, intranets and the Internet.

When used in a LAN networking environment, for example, the computer 1502 is connected to the local network 1564 through a network interface or adapter 1568. When used in a WAN networking environment, the computer 1502 typically includes a modem (e.g., telephone, DSL, cable, etc.) 1570, or is connected to a communications server on the LAN, or has other means for establishing communications over the WAN 1566, such as the Internet. The modem 1570, which can be internal or external relative to the computer 1502, is connected to the system bus 1508 via the serial port interface 1544. In a networked environment, program modules (including application programs 1534) and/or program data 1538 can be stored in the remote memory storage device 1562. It will be appreciated that the network connections shown are exemplary and other means (e.g., wired or wireless) of establishing a communications link between the computers 1502 and 1560 can be used when carrying out an aspect of the subject invention.

In accordance with the practices of persons skilled in the art of computer programming, the subject invention has been described with reference to acts and symbolic representations of operations that are performed by a computer, such as the computer 1502 or remote computer 1560, unless otherwise indicated. Such acts and operations are sometimes referred to as being computer-executed. It will be appreciated that the acts and symbolically represented operations include the manipulation by the processing unit 1504 of electrical signals representing data bits which causes a resulting transformation or reduction of the electrical signal representation, and the maintenance of data bits at memory locations in the memory system (including the system memory 1506, hard drive 1516, floppy disks 1520, CD-ROM 1524, and remote memory 1562) to thereby reconfigure or otherwise alter the computer system's operation, as well as other processing of signals. The memory locations where such data bits are maintained are physical locations that have particular electrical, magnetic, or optical properties corresponding to the data bits.

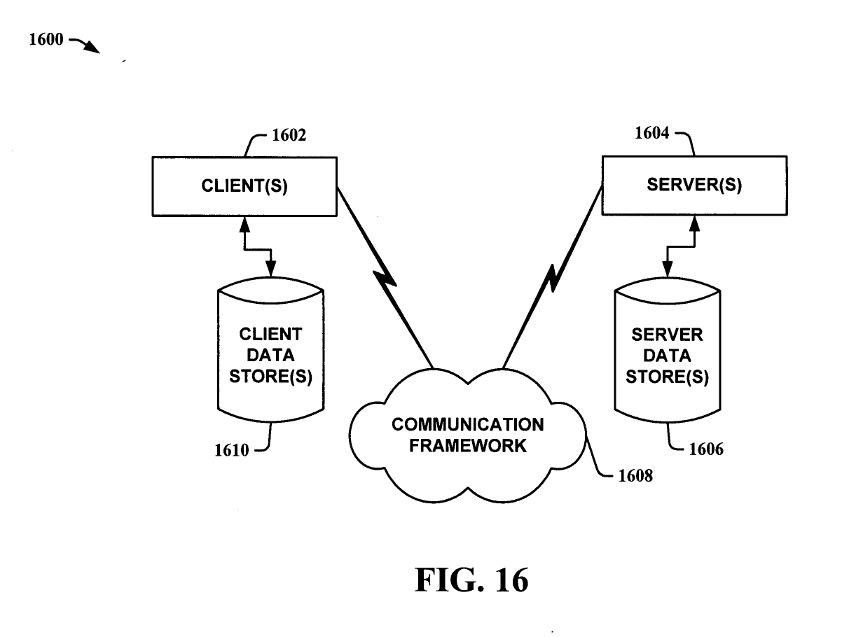

FIG. 16 is another block diagram of a sample computing environment 1600 with which the subject invention can interact. The system 1600 further illustrates a system that includes one or more client(s) 1602. The client(s) 1602 can be hardware and/or software (e.g., threads, processes, computing devices). The system 1600 also includes one or more server(s) 1604. The server(s) 1604 can also be hardware and/or software (e.g., threads, processes, computing devices). One possible communication between a client 1602 and a server 1604 may be in the form of a data packet adapted to be transmitted between two or more computer processes. The system 1600 includes a communication framework 1608 that can be employed to facilitate communications between the client(s) 1602 and the server(s) 1604. The client(s) 1602 are connected to one or more client data store(s) 1610 that can be employed to store information local to the client(s) 1602. Similarly, the server(s) 1604 are connected to one or more server data store(s) 1606 that can be employed to store information local to the server(s) 1604.

It is to be appreciated that the systems and/or methods of the subject invention can be utilized in query optimizer facilitating computer components and non-computer related components alike. Further, those skilled in the art will recognize that the systems and/or methods of the subject invention are employable in a vast array of electronic related technologies, including, but not limited to, computers, servers and/or handheld electronic devices, and the like.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates query processing, comprising:
a receiving component that receives a top-k query for a relational data; and
a query optimization component that determines an optimal execution plan for providing a top-k set of ordered tuples for the query via consideration, at least in part, of a threshold-based process that employs metadata associated with the relational data.

2. The system of claim 1, the threshold-based process employs an adaptation of a Threshold Algorithm (TA) strategy to identify alternative execution plans.

3. The system of claim 2, the query optimization component determines the optimal execution plan via selection of a lowest cost execution plan from the alternative execution plans.

4. The system of claim 1, the metadata comprising at least one index structure associated with the relational data.

5. The system of claim 1, the query optimization component identifies a set of possible execution plans given the query and the relational data metadata.

6. The system of claim 5, the query optimization component employs a pruning process to prune the set of possible execution plans to facilitate in determining the optimal execution plan.

7. The system of claim 6, the pruning process utilizes a number of iterations and a cost per iteration to determine if a possible execution plan exceeds a cost threshold and eliminates possible execution plans that employ similar index structures as the exceeding execution plan.

8. The system of claim 1 further comprising:
a cost model component that evaluates a cost of at least one execution plan determined via a threshold-based process.

9. A relational database management system that employs the system of claim 1.

10. A method of facilitating a top-k selection for relational data queries, comprising:
receiving a top-k query for relational data;
employing a threshold-based process to identify possible execution plans for a search space of the relational data; the identification based, at least in part, on the query and metadata associated with the relational data;
pruning the possible execution plans to facilitate in determining an optimal alternative execution plan;
estimating a cost for each execution plan; and
selecting a minimal cost execution plan as the optimal alternative execution plan.

11. The method of claim 10, the possible execution plans comprising execution plans that utilize a zero or one index with a leading column cᵢ for each attribute cᵢ in a scoring function.

12. The method of claim 10, pruning the possible execution plans comprising:
determining if an execution plan exceeds a cost threshold utilizing a number of iterations and a cost per iteration; and
eliminating possible execution plans that employ similar index structures as the execution plan that exceeds the cost threshold.

13. The method of claim 10 further comprising:
estimating the execution plan cost by employing a process that determines cost based on, at least in part:
$$Cost = D \cdot {T}_{C} ( {\sum }_{{1 \leq i \leq m ,}_{{{c}_{i} usesindex}_{strategy}}} {T}_{{S}_{i}} + {\sum }_{{1 \leq i \leq m ,}_{{{c}_{i} usesnon}_{coveringindex}}} {T}_{L} ) ; \qquad ( Eq . 1 )$$
where the execution plan requires D iterations to finish, T_{C} represents the cost of maintaining a priority queue and calculating scores and threshold values, T_{S}_{ᵢ} is the cost of a sorted access utilizing an index for attribute cᵢ, and T_{L} is a cost of a primary index lookup.

14. The method of claim 13, estimating the execution plan cost further comprising:
obtaining an approximate score of a top-k tuple;
determining a minimum value that results in a threshold value less than the approximate score of the top-k tuple; and
evaluating a cost function utilizing the minimum value as an approximation of the number of iterations D.

15. The method of claim 14 further comprising:
utilizing a small sample for the top-k score; and
employing unidimensional histograms for facilitating in the determination of the number of iterations.

16. The method of claim 15 further comprising:
obtaining top-k scores that are expected to rank in a data set at positions
$$\frac{N + 1}{S + 1} , … , \frac{k \cdot ( N + 1 )}{S + 1}$$
utilizing a precomputed small sample, where N is a number of tuples in a data set table and S is a sample size;
determining an expected number of iterations for each score utilizing single-column histograms; and
deriving an optimal curve that approximates a number of iterations function and evaluating it in k to facilitate in obtaining D.

17. A query optimizer for a relational database employing the method of claim 10 to facilitate in selecting an optimal query execution plan.

18. A scan-based query optimizer employing the method of claim 10 to augment sequential scan-based processes.

19. A system that facilitates query processing, comprising:
means for receiving a top-k query for a relational database; and
means for determining an optimal execution plan for providing a top-k set of ordered tuples for the query via consideration of a threshold-based process that employs metadata associated with the relational database.

20. The system of claim 19 further comprising:
means for comparing costs of execution plans determined via the threshold-based process and/or a sequential scan-based process.
